(19) United States
(12) Patent Application Publication
(10) Pub. No.: US 2023/0033586 A1
(43) Pub. Date: Feb. 2, 2023

(54) IN-VEHICLE CONTROL DEVICE

(71) Applicant: TOYOTA JIDOSHA KABUSHIKI KAISHA, Toyota-shi (JP)

(72) Inventors: Keiji KAITA, Miyoshi-shi (JP); Masaya Yamamoto, Toyota-shi (JP); Koichi Kojima, Toyota-shi (JP); Takahiko Hirasawa, Toyota-shi (JP)

(73) Assignee: TOYOTA JIDOSHA KABUSHIKI KAISHA, Toyota-shi (JP)

(21) Appl. No.: 17/845,366

(22) Filed: Jun. 21, 2022

(30) Foreign Application Priority Data
Jul. 31, 2021 (JP) 2021-126347

(51) Int. Cl. G07C 5/02; G07C 5/08

(52) U.S. Cl. CPC G07C 5/02; G07C 5/0816

(57) ABSTRACT

An in-vehicle control device mounted on a vehicle includes an electronic control unit configured to determine that there is a possibility that damage to a bottom portion of the vehicle occurs when a vertical acceleration, which is an acceleration in a vertical direction of the vehicle, or a vertical acceleration increase rate, which is an amount of increase in the vertical acceleration per unit time, reaches a first threshold value or higher.

### CROSS-REFERENCE TO RELATED APPLICATION

This application claims priority to Japanese Patent Application No. 2021-126347 filed on Jul. 31, 2021, incorporated herein by reference in its entirety.

### BACKGROUND

### 1. Technical Field

The disclosure relates to an in-vehicle control device.

### 2. Description of Related Art

In related art, as this kind of technology, a vehicle in which a battery that supplies electric power to a drive motor is mounted in a space under a floor panel has been proposed (see, for example, Japanese Unexamined Patent Application Publication No. 2020-104556 (JP 2020-104556 A)).

### SUMMARY

When a vehicle climbs over a step, falls into a ditch, travels on a traveling road with a protrusion, and the like, there is the possibility that damage to a bottom portion of a vehicle (for example, an undercover) occurs. When damage occurs at the bottom portion of the vehicle, there is the possibility that damage also occurs at a part, for example, a battery disposed in a space between a floor panel and the bottom portion. Therefore, how to detect the possibility that damage to the bottom portion of the vehicle occurs has become an issue.

An in-vehicle control device of an aspect of the disclosure is configured to detect the possibility that damage occurs at the bottom portion of the vehicle.

The disclosure relates to an in-vehicle control device mounted on a vehicle.

An electronic control unit is configured to determine that there is a possibility that damage to a bottom portion of the vehicle occurs when a vertical acceleration, which is an acceleration in a vertical direction of the vehicle, or a vertical acceleration increase rate, which is an amount of increase in the vertical acceleration per unit time, reaches a first threshold value or higher, is included.

With the in-vehicle control device, the electronic control unit determines that there is a possibility that damage to a bottom portion of the vehicle occurs when a vertical acceleration, which is an acceleration in a vertical direction, or a vertical acceleration increase rate, which is an amount of increase in the vertical acceleration per unit time of the vehicle, reaches a first threshold value or higher. Based on analysis and experiments, the inventors have confirmed that the vertical acceleration or the vertical acceleration increase rate is likely to be relatively greater and that there is the possibility that damage to the bottom portion of the vehicle occurs when a vehicle climbs over a step, falls into a ditch, travels on a traveling road with a protrusion, and the like. Therefore, when the vertical acceleration or the vertical acceleration increase rate reaches the first threshold value or more, it is possible to detect the possibility that damage to the bottom portion of the vehicle occurs.

In the in-vehicle control device of the aspect of the disclosure, the electronic control unit may be configured to determine that there is a possibility that damage to the bottom portion occurs when the vertical acceleration or the vertical acceleration increase rate reaches the first threshold value or higher and an air pressure increase rate, which is an amount of increase in an air pressure of a tire of the vehicle per unit time, reaches a second threshold value or higher. In this way, it is possible to more appropriately determine the presence or absence of a possibility in which damage to the bottom portion of the vehicle occurs.

In the in-vehicle control device of the aspect of the disclosure, the electronic control unit may be configured to propose an inspection of the vehicle when the electronic control unit determines that there is a possibility that damage to the bottom portion occurs. When the vehicle is brought to a dealer and the like in this way, the worker can confirm the presence or absence of damage to the bottom portion.

In the in-vehicle control device of the aspect of the disclosure, the vehicle may include an engine having an exhaust pipe and a fuel tank that supplies fuel to the engine, and at least one of the fuel tank or the exhaust pipe may be disposed on an upper surface side of the bottom portion. Further, the vehicle may include a motor for traveling and a power storage device that supplies electric power to the motor, and the power storage device may be disposed on the upper surface side of the bottom portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing an outline of a configuration of a hybrid electric vehicle as an example of the disclosure;

FIG. 2 is a layout diagram showing a state of disposition of each component of the hybrid electric vehicle;

FIG. 3 is a flowchart showing an example of a processing routine executed by an electronic control unit; and

FIG. 4 is a flowchart showing an example of the processing routine executed by the electronic control unit.

### DETAILED DESCRIPTION OF EMBODIMENTS

Next, an embodiment for carrying out the disclosure will be described with reference to examples.

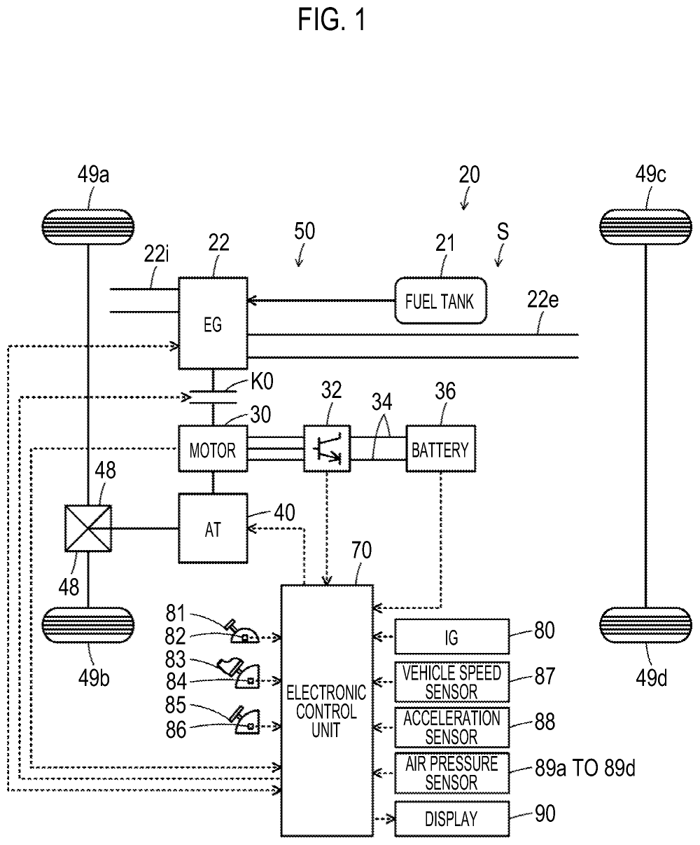

FIG. 1 is a configuration diagram showing an outline of a configuration of a hybrid electric vehicle 20 as an example of the disclosure. The hybrid electric vehicle 20 of the example is configured as a front-wheel drive vehicle, and as shown in the figure, includes a fuel tank 21, an engine 22, a clutch K0, a motor 30, an inverter 32, a battery 36 as a power storage device, a transmission 40, and an electronic control unit 70.

The engine 22 has an intake pipe 22i and exhaust pipe 22e, a throttle valve, a fuel injection valve, an ignition plug, and the like, and is configured as an internal combustion engine that outputs power by four strokes of intake, compression, expansion (combustion explosion), exhaust by using fuel such as gasoline and diesel oil from the fuel tank 21. The exhaust gas of the engine 22 is discharged to the outside air via the exhaust pipe 22e. The clutch K0 is configured as, for example, a hydraulically driven friction clutch, and performs connection and disconnection between the crankshaft of the engine 22 and a rotor of the motor 30. The motor 30 is configured as, for example, a synchronous power generator motor. The inverter 32 is used for driving the motor 30 and is connected to the battery 36 via an electric power line 34. The battery 36 is configured as, for example, a lithium ion secondary battery or a nickel hydrogen secondary battery.

The transmission 40 is configured as an automatic transmission such as 4-speed, 5-speed, 6-speed, and 8-speed, and has an input shaft, an output shaft, a plurality of planetary gears, and a plurality of hydraulically driven frictional engagement elements (clutch and brake). The input shaft is connected to the rotor of the motor 30, and the output shaft is connected to front wheels 49a, 49b as driving wheels via a differential gear 48. The transmission 40 forms a plurality of forward stages and reverse stages by setting the frictional engagement elements in an engagement state or a disengagement state, to connect the input shaft and the output shaft (transfer power between the two) or disconnect the input shaft and the output shaft.

Although not shown, the electronic control unit 70 includes a microcomputer having a CPU, a ROM, a RAM, a flash memory, an input and output port, and a communication port. Signals from various sensors are input to the electronic control unit 70 via the input port. The signal input to the electronic control unit 70 can include, for example, signals from various sensors that detect the states of the fuel tank 21, the engine 22, the clutch K0, the motor 30, the inverter 32, the battery 36, the transmission 40, and the like. The start signal from a start switch 80 and a shift position SP from a shift position sensor 82 that detects the operation position of a shift lever 81 can also be mentioned. An accelerator operation amount Acc from an accelerator pedal position sensor 84 that detects an amount of depression of an accelerator pedal 83, and a brake pedal position BP from a brake pedal position sensor 86 that detects an amount of depression of a brake pedal 85 can also be mentioned. A vehicle speed V from a vehicle speed sensor 87, accelerations αx, αy, αz in the front-rear direction, the right and left direction, and the vertical direction of the vehicle from an acceleration sensor 88, air pressures Pwa to Pwd from air pressure sensors 89a to 89d that detect the air pressure of the front wheels 49a, 49b as the driving wheels and rear wheels 49c, 49d as driven wheels can also be mentioned. Various control signals are output from the electronic control unit 70 via the output port. The signal output from the electronic control unit 70 can include, for example, a control signal to the engine 22 and the clutch K0, the inverter 32, the transmission 40, and the display 90.

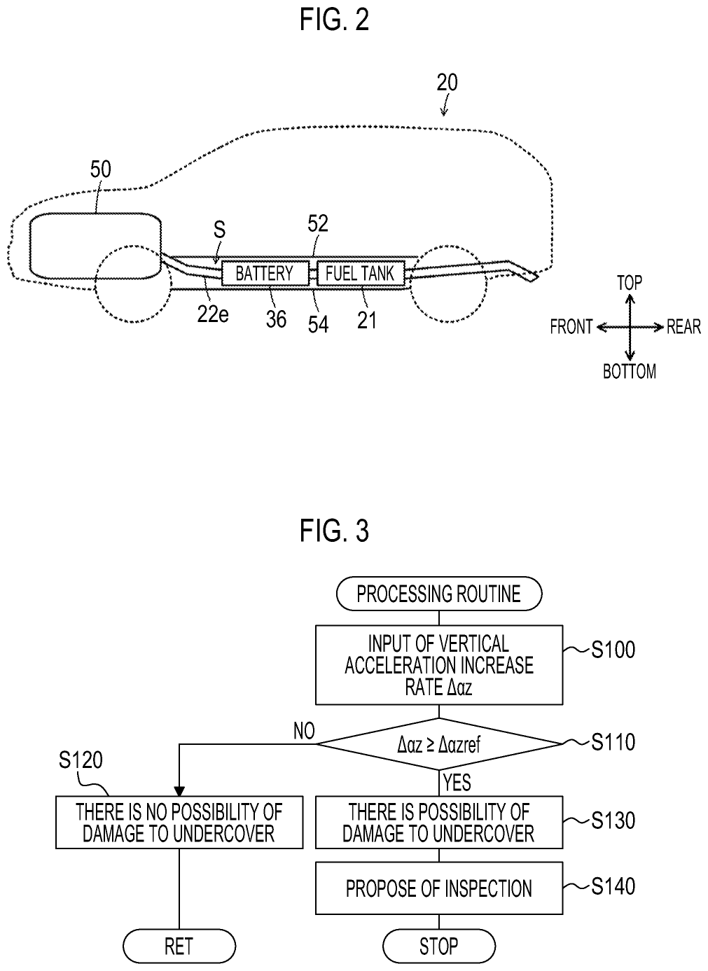

FIG. 2 is a layout diagram showing the disposition of each component of the hybrid electric vehicle 20. As shown in FIGS. 1 and 2, the engine 22, the clutch K0, the motor 30, the inverter 32, the transmission 40, and the electronic control unit 70 are disposed in an engine compartment 50 at the front of the vehicle. The fuel tank 21 and the battery 36 are disposed in a space S surrounded by a floor panel 52 and an undercover 54, and are fixed to a body (vehicle body) (not shown) by bolts and the like. The undercover 54 is also fixed to the body with bolts and the like. The exhaust pipe 22e of the engine 22 is disposed to protrude from the engine compartment 50 to the outside of the vehicle at the rear of the vehicle via the space S.

The hybrid electric vehicle 20 of the example configured in this way travels in the hybrid electric traveling (HEV traveling) mode or the battery electric traveling (BEV traveling) mode. Here, the HEV traveling mode is a traveling mode in which the clutch K0 is in the engagement state and the traveling is accompanied by the rotation of the engine 22. The BEV traveling mode is a traveling mode in which the clutch K0 is in the disengagement state and the traveling is accompanied by the rotation stop of the engine 22.

Next, the operation of the hybrid electric vehicle 20 of the example configured in this way, particularly the operation at the time of determining the possibility of damage to the undercover 54 will be described. FIG. 3 is a flowchart showing an example of a processing routine executed by the electronic control unit 70. The routine is repeated when the possibility of damage to the undercover 54 is not detected.

When the processing routine of FIG. 3 is executed, the electronic control unit 70 first inputs a vertical acceleration increase rate Δαz of the vehicle (step S100). Here, the vertical acceleration increase rate Δαz of the vehicle is input with a value calculated as the amount of increase in an acceleration αz in a vertical direction of the vehicle detected by the acceleration sensor 88 per unit time (the amount of increase in an absolute value of the acceleration αz with the same sign, that is, the amount of increase in the acceleration αz in the upward direction or the amount of increase in the acceleration αz in the downward direction).

When the data is input in this way, the electronic control unit 70 determines whether the input vertical acceleration increase rate Δαz of the vehicle is equal to or greater than a threshold value Δαzref (step S110). Here, the threshold value Δαzref is a threshold value used to determine the presence or absence of the possibility of damage to the undercover 54. Based on analysis and experiments, the inventors have confirmed that the vertical acceleration increase rate Δαz is likely to be relatively greater and that there is the possibility that damage to the undercover 54 occurs when a vehicle climbs over a step, falls into a ditch, travels on a traveling road with a protrusion, and the like. Further, when the undercover 54 is damaged, the fuel tank 21, the exhaust pipe 23 of the engine 22, the battery 36, and the like, which are disposed in the space S between the floor panel 52 and the undercover 54, are also confirmed to have the possibility of being damaged. The processing of step S110 is processing performed based on the above-described.

When the electronic control unit 70 determines in step S110 that the vertical acceleration increase rate Δαz of the vehicle is less than the threshold value Δαzref, the electronic control unit 70 determines that there is no possibility of damage to the undercover 54 (step S120), and the routine is terminated. On the other hand, when the electronic control unit 70 determines in step S110 that the vertical acceleration increase rate Δαz of the vehicle is equal to or greater than the threshold value Δαzref, the electronic control unit 70 determines that there is the possibility of damage to the undercover 54 (step S130) and proposes an inspection of the vehicle (step S140) to terminate the routine. In this way, the possibility of damage to the undercover 54, and furthermore, the possibility of damage to the fuel tank 21, the exhaust pipe 23 of the engine 22, the battery 36, and the like disposed in the space S, can be detected. In the processing of step S140, for example, a message such as “Please bring the vehicle to a dealer or a shop to inspect the vehicle” is displayed on the display 90. Then, when the vehicle is brought to a dealer or a shop by the driver, a worker such as a dealer confirms the presence or absence of damage to the undercover 54, the fuel tank 21, the exhaust pipe 23 of the engine 22, the battery 36, and the like and can perform relevant repairs and parts replacement.

In the electronic control unit 70 as an in-vehicle control device mounted on the hybrid electric vehicle 20 of the above-described example, when the vertical acceleration increase rate Δαz reaches the threshold value Δαzref or higher, the electronic control unit 70 determines that there is the possibility of damage to the undercover 54. In this way, the possibility of damage to the undercover 54, and furthermore, the possibility of damage to the fuel tank 21, the exhaust pipe 23 of the engine 22, the battery 36, and the like can be detected.

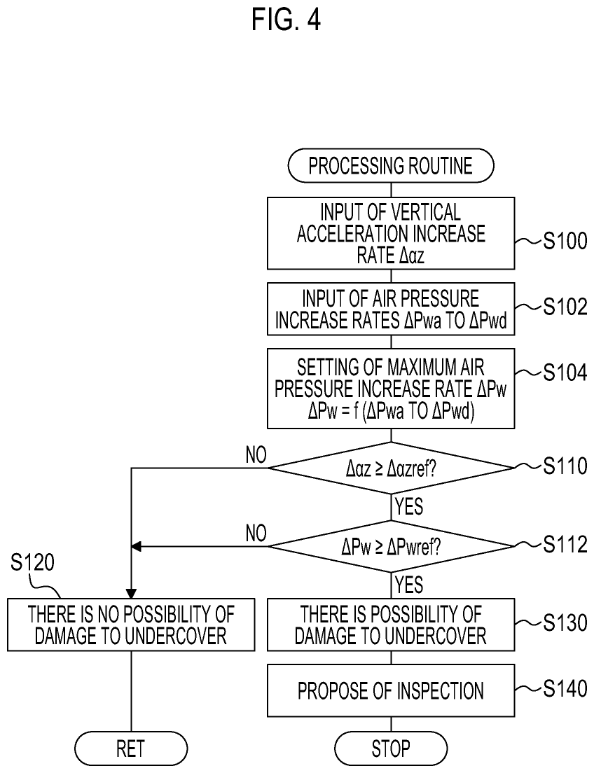

In the electronic control unit 70 mounted on the hybrid electric vehicle 20 of the example, the processing routine of FIG. 3 is executed. However, instead of this, the processing routine of FIG. 4 may be executed. The processing routine of FIG. 4 is the same as the processing routine of FIG. 3 except that the processing of steps S102, S104, S112 is added. Therefore, among the processing routines of FIG. 4, the same processing as that of the processing routine of FIG. 3 is assigned the same step number, and detailed description thereof will be omitted.

In the processing routine of FIG. 4, the electronic control unit 70 inputs air pressure increase rates ΔPwa to ΔPwd of the front wheels 49a, 49b and the rear wheels 49c, 49d in addition to inputting the vertical acceleration increase rate Δαz in the processing of step S100 (Step S102), and sets the maximum value among the input air pressure increase rates ΔPwa to ΔPwd of the front wheels 49a, 49b and the rear wheels 49c, 49d to a maximum air pressure increase rate ΔPw (step S104). Here, the air pressure increase rates ΔPwa to ΔPwd of the front wheels 49a, 49b and the rear wheels 49c, 49d are input with values calculated as the amount of increase in the air pressures Pwa to Pwd of the front wheels 49a, 49b and the rear wheels 49c, 49d detected by the air pressure sensors 89a to 89d per unit time.

When the data is input in this way, the electronic control unit 70 determines whether the vertical acceleration increase rate Δαz of the vehicle is equal to or greater than the threshold value Δαzref (step S110) and determines whether the maximum air pressure increase rate ΔPw is equal to or greater than a threshold value ΔPwref (step S112). Here, the threshold value ΔPwref is a threshold value used to determine the presence or absence of the possibility of damage to the undercover 54, in the same manner as the threshold value Δαzref. When the volume of the front wheels 49a, 49b and the rear wheels 49c, 49d decreases due to an external force, such as when a vehicle climbs over a step, falls into a ditch, and travels on a traveling road with a protrusion, the air pressures Pwa to Pwd of the front wheels 49a, 49b and the rear wheels 49c, 49d increase. The processing of steps S110 and S112 is the processing that is performed based on the above-mentioned and the fact that the vertical acceleration increase rate Δαz is likely to be relatively greater and there is the possibility that damage to the undercover 54 occurs when a vehicle climbs over a step, falls into a ditch, travels on a traveling road with a protrusion, and the like, as described above.

When the electronic control unit 70 determines in step S110 that the vertical acceleration increase rate Δαz of the vehicle is less than the threshold value Δαzref, or when the electronic control unit 70 determines in step S112 that the maximum air pressure increase rate ΔPw is less than the threshold value ΔPwref, the electronic control unit 70 determines that there is no possibility of damage to the undercover 54 (step S120) to terminate the routine. On the other hand, when the electronic control unit 70 determines in step S110 that the vertical acceleration increase rate Δαz of the vehicle is equal to or greater than the threshold value Δαzref, and determines in step S112 that the maximum air pressure increase rate ΔPw is equal to or greater than the threshold value ΔPwref, the electronic control unit 70 determines that there is the possibility of damage to the undercover 54 (step S130) and proposes an inspection of the vehicle (step S140) to terminate the routine. In this way, the possibility of damage to the undercover 54, and furthermore, the possibility of damage to the fuel tank 21, the exhaust pipe 23 of the engine 22, the battery 36, and the like can be more appropriately detected.

In the electronic control unit 70 mounted on the hybrid electric vehicle of the example and the modification example, the vertical acceleration increase rate Δαz is compared with the threshold value Δαzref in the processing routines of FIGS. 3 and 4. However, instead of the above-mentioned, the absolute value of the vertical acceleration αz may be compared with the threshold value αzref. This is because using the vertical acceleration αz instead of the vertical acceleration increase rate Δαz is considered to be the same.

In the example, the hybrid electric vehicle 20 is configured as a front-wheel drive vehicle. However, the hybrid electric vehicle 20 may be configured as a rear-wheel drive vehicle or a four-wheel drive vehicle.

In the example, the electronic control unit 70 as an in-vehicle control device mounted on the hybrid electric vehicle 20 is used. However, the electronic control unit 70 may be in the form of an in-vehicle control device mounted on a battery electric vehicle or a fuel cell electric vehicle that travels by using power from a motor without an engine, or may be in the form of an in-vehicle control device mounted on a general engine vehicle that travels by using power from an engine without a motor for traveling.

As for the correspondence between the main elements of the example and the main elements of the disclosure described in the section of means for solving problems, since the example is an example for specifically describing a mode to carry out the disclosure described in the section of means for solving problems, the elements of the disclosure described in the section of means for solving problems are not limited to the embodiment. That is, the interpretation of the disclosure described in the section of means for solving problems should be performed based on the description in the section, and the example is just a concrete example of the disclosure described in the section of means for solving problems.

Although the embodiment for carrying out the disclosure has been described above with reference to the example, the disclosure is not limited to the example, and of course can be carried out in various modes within a scope without departing from the gist of the disclosure.

The disclosure can be used in the manufacturing industry of the in-vehicle control device and the like.

What is claimed is:

1. An in-vehicle control device mounted on a vehicle, the in-vehicle control device comprising an electronic control unit configured to determine that there is a possibility that damage to a bottom portion of the vehicle occurs when a vertical acceleration, which is an acceleration in a vertical direction of the vehicle, or a vertical acceleration increase rate, which is an amount of increase in the vertical acceleration per unit time, reaches a first threshold value or higher.

2. The in-vehicle control device according to claim 1, wherein the electronic control unit is configured to determine that there is a possibility that damage to the bottom portion occurs when the vertical acceleration or the vertical acceleration increase rate reaches the first threshold value or higher and an air pressure increase rate, which is an amount of increase in an air pressure of a tire of the vehicle per unit time, reaches a second threshold value or higher.

3. The in-vehicle control device according to claim 1, wherein the electronic control unit is configured to propose an inspection of the vehicle when the electronic control unit determines that there is a possibility that damage to the bottom portion occurs.

4. The in-vehicle control device according to claim 1, wherein:
the vehicle includes an engine having an exhaust pipe and a fuel tank that supplies fuel to the engine; and
at least one of the fuel tank or the exhaust pipe is disposed on an upper surface side of the bottom portion.

5. The in-vehicle control device according to claim 1, wherein:
the vehicle includes a motor for traveling and a power storage device that supplies electric power to the motor; and
the power storage device is disposed on an upper surface side of the bottom portion.
